(19) United States
(12) Patent Application Publication
(10) Pub. No.: US 2015/0122007 A1
(43) Pub. Date: May 7, 2015

(54) WIND DETECTOR FOR WIND TURBINE GENERATORS

(71) Applicant: VESTAS WIND SYSTEMS A/S, Aarhus N (DK)

(72) Inventor: Ib Svend Olesen, Randers (DK)

(73) Assignee: VESTAS WIND SYSTEMS A/S, Aarhus N (DK)

(21) Appl. No.: 14/362,994

(22) PCT Filed: Dec. 7, 2012
(86) PCT No.: PCT/DK2012/050448

§ 371 Date: Jun. 5, 2014

(30) Foreign Application Priority Data
Dec. 8, 2011 (DK) PA 2011 70688

(51) Int. Cl. G01P 13/02; G01N 21/53

(52) U.S. Cl. CPC G01P 13/02; G01N 21/53
USPC 73/170.06

(57) ABSTRACT

The invention relates to an optical detector for determining the relative wind direction (attack angle) relative to a rotating or stationary wind turbine rotor. The optical detector comprises an output part which transmits distinguishable light beams out from a rotor blade in different predetermined directions. The beams may be distinguishable by light color, by the time the individual beams are emitted and/or by different amplitude modulation frequencies or other modulations of the individual beams. By determining pulse times of scattered light from wind borne particles moving in or through the different distinguishable beams, or determining the number of pulses within a period, it is possible to determine the relative wind direction or angle of attach as the predetermined direction of a beam which has the longest pulse times or the fewest number of pulses within a given period of time.

### FIELD OF THE INVENTION

The invention relates to an optical device for measuring wind directions, and particularly for such optical devices for use with wind turbine generators.

### BACKGROUND OF THE INVENTION

Measuring the wind at a single location in front of the rotor may be inadequate for wind turbine generators with long blades since wind speed and wind direction may vary along the length of the blades.

By knowing the wind condition at different places in the area swept by the blades, the determination of the pitch angle of the blades may be improved with respect to power production.

Accordingly, there is a need to enable measurement of wind direction and/or wind speed at different locations in the area swept by the rotor of a wind turbine generator.

### SUMMARY OF THE INVENTION

It would be advantageous to achieve improvements within measurements of wind detection. In general, the invention preferably seeks to alleviate or eliminate the above mentioned disadvantages of wind detection. In particular, it may be seen as an object of the present invention to provide a method that enables detection of wind speed and/or wind direction at different locations in the area swept by rotor, or other problems, of the prior art.

To better address one or more of these concerns, in a first aspect of the invention an optical wind detector for wind turbine generators for determining a relative wind direction relative to a location on a blade of a rotor of the wind turbine generator is presented that comprises
an optical beam generator comprising an output part capable of outputting light in first and second different directions from the location on the blade,
an optical receiver capable of measuring a first optical quantity determined from measured optical scattered light originating from the first direction and a second optical quantity determined from measured optical scattered light originating from the second direction.

The output part is intended for mounting at the location of the blade so that it emits light in front of the rotor in a direction against the incoming wind, or behind the rotor in a direction of the incoming wind. The receiver may be located on the same blade as the output part, or elsewhere on the wind turbine generator.

It is understood that the output part may output light in more than first and second directions, e.g. light beams may be outputted in 5, 10, 20 or more directions. In practice, use of a dispersive element such as a prism may generate an infinite range of light beams since incoming white light is dispersed into a continuous spreading of the incoming white light in different directions where the light in the different directions has different wavelengths. Similarly, the receiver may be capable of determining more than first and second quantities of measured scattered light from more than respective first and second directions.

Since the first and second optical quantities are associated with first and second directions, the relative wind direction can be determined as the first or second light direction by analysing the determined first and second quantities. If the optical quantities are counts of light pulses from particles, the relative wind direction may be determined as the light direction of the first and second directions which is associated with the lowest count of light pulses. If the optical quantities are durations of light pulses from particles, the relative wind direction may be determined as the light direction of the first and second directions which is associated with the longest durations of light pulses.

Advantageously, the output part located at the rotor enables detection of the relative wind direction for different locations within the area swept by the rotor. Two or more output parts may be located along the length of a blade to enable determination of wind conditions at different radial distances.

The determination of the wind direction as enabled by the optical wind detector may improve the determination of the pitch angle of the blades and, thereby, improve power production since the pitch may be set close to optimal production angle which is dependent on the relative wind direction. Additionally, stall effects of the blades may be avoided and, thereby, noise from blades and fatigue loads may be minimized.

Advantageous, light may be supplied to the output part via one or more optical fibers extending though the blades and into the hub, and light received by the optical receiver may be transmitted via the same one or more fibers or other fibers to the hub for conversion of optical quantities to electrical quantities. However, such fibers may not be part of the optical wind detector, but may be connectable with the optical connectors of the optical wind detector.

In an embodiment the first optical quantity may be determined as a duration of a pulse and/or a count of pulses of measured optical scattered light originating from the first direction and the second optical quantity may be determined as a duration of a pulse and/or a count of pulses of measured optical scattered light originating from the second direction.

In an embodiment the output part may comprise an optical prism configured to receive input light with a given spectrum and to output the received light as light with a first wavelength in the first direction and light with a second wavelength in the second direction. The spectrum may comprise the first and second wavelengths or more wavelengths in a continuous spectrum or non-contiguous spectra.

In an embodiment the spectrum may vary with time so that that the first and second wavelengths are present in the spectrum at different times.

In an embodiment the output part comprises first and second optical fibers arranged to output light in the first and second directions. The light transmission in the first and second optical fibers may be multiplexed so that the output light in the first and second directions is generated at different times.

In an embodiment the optical wind detector comprises a processor configured to determine the relative wind direction by analysis of the first and second optical quantities. The analysis for determining the relative wind direction may comprise determining, within a period of time, which of the first and second quantities comprises the longest durations of pulses and/or lowest count of pulses. Additionally or alternatively, the analysis may comprise interpolating or extrapolating, values of the first and second optical quantities for the first and second different directions, for determining a direction of the relative wind direction which is not coincident with any of the first and second directions. Additionally or alternatively, the optical wind detector may further be configured to determine wind velocity from the relative wind direction and rotor speed of the rotor of the wind turbine.

In an embodiment the processor may further be configured to determine the relative wind direction for different angular positions of the rotor. In this way it is possible to determine if the rotor direction is optimal by comparing the wind directions at different angular orientations of the rotor.

A second aspect of the invention relates to a wind turbine comprising the optical wind detector according to the first aspect. The output part may be mounted at the location of the blade.

A third aspect of the invention relates to a method for determining for determining a relative wind direction relative to a location on a blade of a rotor of a wind turbine generator, the method comprises
outputting light in first and second different directions from the location on the blade by use of an optical beam generator,
determining a first optical quantity from measured optical scattered light originating from the first direction, and
determining a second optical quantity from measured optical scattered light originating from the second direction.

In summary the invention relates to an optical detector for determining the wind direction relative to a rotating or stationary wind turbine rotor. The optical detector comprises an output part which transmits distinguishable light beams out from a rotor blade in different predetermined directions. The beams may be distinguishable by light color, by the time the individual beams are emitted and/or by different amplitude modulation frequencies or other modulations of the individual beams. By determining pulse times of scattered light from wind borne particles moving in or through the different distinguishable beams, or determining the number of pulses within a period, it is possible to determine the relative wind direction or angle of attach as the predetermined direction of a beam which has the longest pulse times or the fewest number of pulses within a given period of time.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows a wind turbine generator,

FIG. 2 illustrates the optical principle for measuring the relative wind direction by outputting beams in different directions from a blade,

FIG. 3 shows the geometry for determining wind speed,

FIG. 4A-D shows different optical principles for generating optical beams at different directions, and

FIG. 5 illustrates components of the optical wind detector.

### DETAILED DESCRIPTION OF EMBODIMENTS

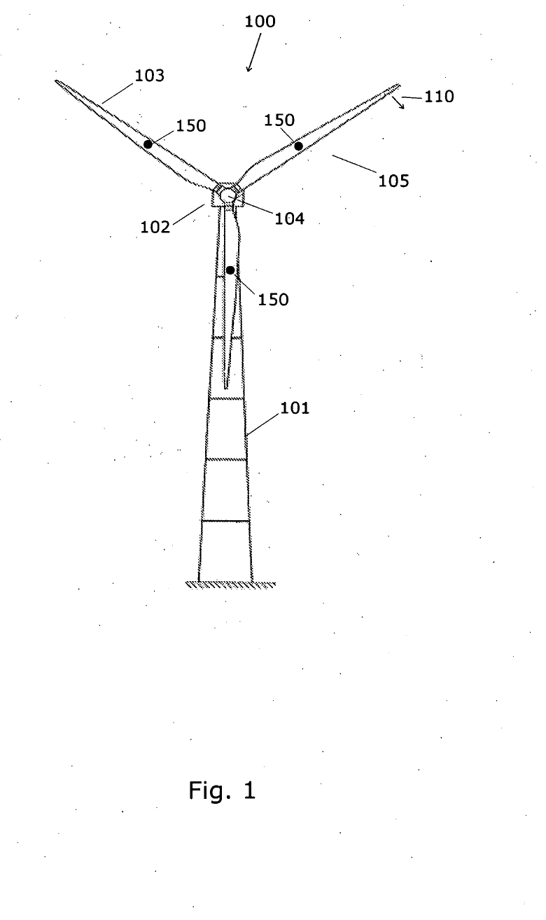

FIG. 1 shows a wind turbine generator 100 comprising a tower 101 and a nacelle 102. Rotor blades 103 are fixed to a hub 104. The assembly of rotor blades 103, i.e. the rotor 105, is rotatable by action of the wind. The rotation direction is indicated by direction 110. Thus, the wind induced rotational energy of the rotor blades 102 may be transferred via the hub to a generator in the nacelle. Thus, the wind turbine generator 100 is capable of converting energy of the wind into mechanical energy by means of the rotor blade and, subsequently, into electric energy by means of the generator.

Rotor blades 103 or just blades 103 includes, but is not limited to, an elongated structure having an air foil-shaped profile suitable for providing an aerodynamic lift upon relative movement through air.

The hub 104 is a structure provided with fastening means for fastening one or more rotor blades 103 and connectable with a shaft for transferring the rotational energy of the blades to the generator or a gearbox.

According to an embodiment of this invention an output part 150 of an optical wind detector is connected to one or more of the blades 103, e.g. one detector 150 connected to each of the three blades as shown in FIG. 1.

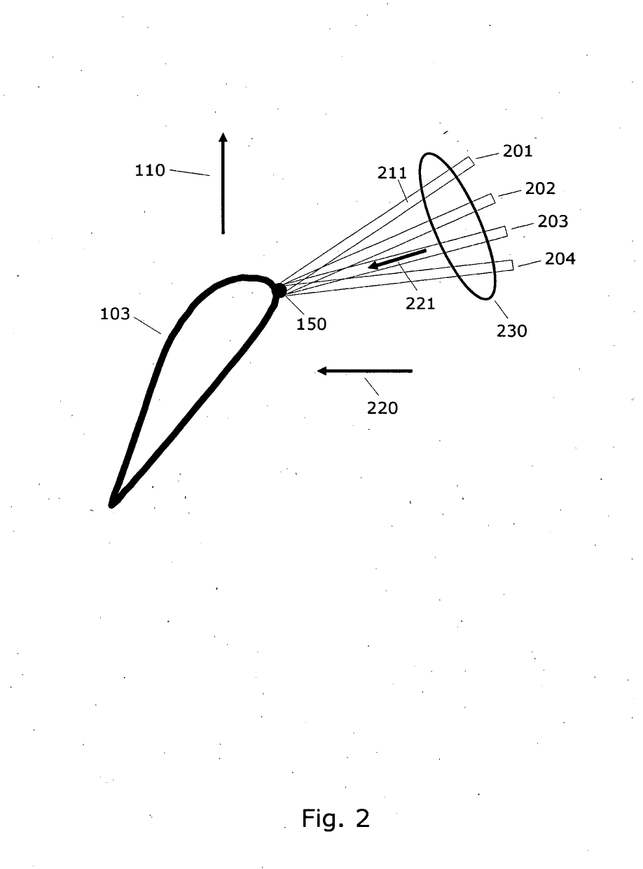

FIG. 2 shows a cross sectional view of a blade 103 at a longitudinal location of the blade 103. The blade in FIG. 2 has an upright direction parallel with the tower 101. The rotation direction is given by blade direction 110 and the direction of the incoming wind is approximately given by wind direction 220.

An output part 150 of an optical wind detector is located at the leading edge of the blade. The output part 150 outputs light in different directions 201-204, such as first and second directions 201-202.

The incoming wind will contain a large number of small particles, such as dust, pollen, water droplets and ice crystals. A portion of the light transmitted into the air—and through the volume 230—by the output part 150 will be scattered by the particles, such as particles located within a volume 230. The scattered light is received by an optical receiver which may be located on the same blade as the output part 150 is connected to, or elsewhere on the wind turbine 100 such as on the nacelle 102 or hub 104. As an example, a receiving part of the optical receiver, e.g. a lens, may be combined with the output part 150. For example, the same lens or other optical component mounted in an aperture of the shell of the blade 103 may be used both for outputting light and for receiving scattered light.

The scattered light received and measured by the optical receiver may be quantified in terms a duration of one or more pulses and/or a count of pulses of measured optical scattered light originating from individual beams 211. Thus, the optical receiver will generate a pulse, i.e. a measured optical power, energy or intensity which remains within a given intensity range, for a duration which is equivalent to the period wherein a particle scatters light from a given beam with a given direction 201-204.

It can be assumed that the particles are approximately evenly distributed in the air and, therefore, the concentration of particles passing through the volume 230 is substantially independent of the location within the volume 230. Therefore, particles which move in a given absolute direction 220 will scatter light for a longer period of time while is passes a beam having a direction 204 than a beam having a direction 203 if direction 204 is closer to the relative direction of the particle than direction 203. Similarly, particles which move in a given absolute direction 220 will generate a lower count of pulses within a given period of time from a beam having a direction 204 than a beam having a direction 203, if direction 204 is closer to the relative direction of the wind borne particle than direction 203.

Herein a beam is understood as light rays outputted from the output part 150 which propagates within a fan, i.e. within a given angle or solid angle. Thus, a plurality of individual beams can be defined in a single divergent beam outputted from the output part 150 by splitting up the main beam into more narrow fans of rays. Accordingly, each of the beam directions 201-204 has an associated beam of rays as illustrated by a beam 211.

Assuming that the wind has the direction 220, e.g. the beam associated with direction 201 may generate scattering pulses which are longer in time than scattering pulses from any of the other beams associated with directions 202-204. Equivalently, the beam associated with direction 201 may generate a lower count of scattering pulses than scattering pulses from any of the other beams associated with directions 202-204. Accordingly, by determining which beam of the beams 211 associated with directions 201-204 generates the longest scattering pulse, and/or the lowest count of pulses the relative direction of the wind can be determined as the direction 201-204 which is associated with the longest scattering pulse or lowest count of pulses. The determined relative wind direction is indicated by direction 221. The accuracy of the determined relative wind direction 221 can be improved by interpolation or extrapolation of the measured optical quantities of scattered light—e.g. pulse lengths or pulse counts—from different directions 201-204.

It is important to recognize that the wind direction 220 is an absolute direction independent from the rotation of blades 103, whereas a relative wind direction 221 as determined by the optical wind detector gives the wind direction relative to the rotating or stationary rotor 105.

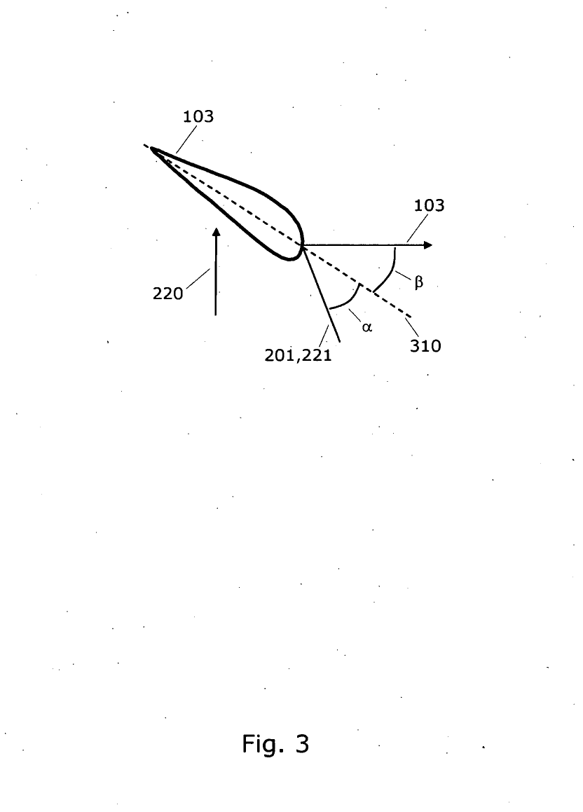

FIG. 3 illustrates the same cross sectional view of a blade 103 as in FIG. 2 with rotation direction 103 and wind direction 220. The chord line 310 defines a line passing through the trailing and leading edges. The angle β between the rotation direction 103 and the chord line 310 is the pitch angle of the blade or part of the blade which can be adjusted by a pitch actuator.

In FIG. 3 wind direction 220 presents the assumed absolute wind direction, whereas it has been found that the actual relative wind direction 221 is equal to or approximately equal to the direction 201 of an associated light beam 211. Accordingly, the relative wind direction 221 is determined as the angle α, or angle of attack, relative to chord direction 310.

The determined relative wind direction a is determined relative to a given location on the blade 103, e.g. the location where the output part 150 is located. Thus, different relative wind directions a may be determined along the length of the blade which may be important for determining the optimal pitch angle β for blades with a length of e.g. 50 meters or more.

Assuming that the absolute wind direction 220 is substantially perpendicular to the rotor direction 103, the wind speed along wind direction 220 or the wind speed along the relative wind direction 221 can be determined. Thus, the wind speed ws along the wind direction 220 is given by ws=rs/tan (α+β), and the relative wind speed rws along the relative wind direction 221 is given by rws=rs/cos (α+β), where rs is rotor speed in meters per second.

The optical beam generator and the output part 150 may be configured in different ways for outputting light in different directions such as first and second different directions 201, 202.

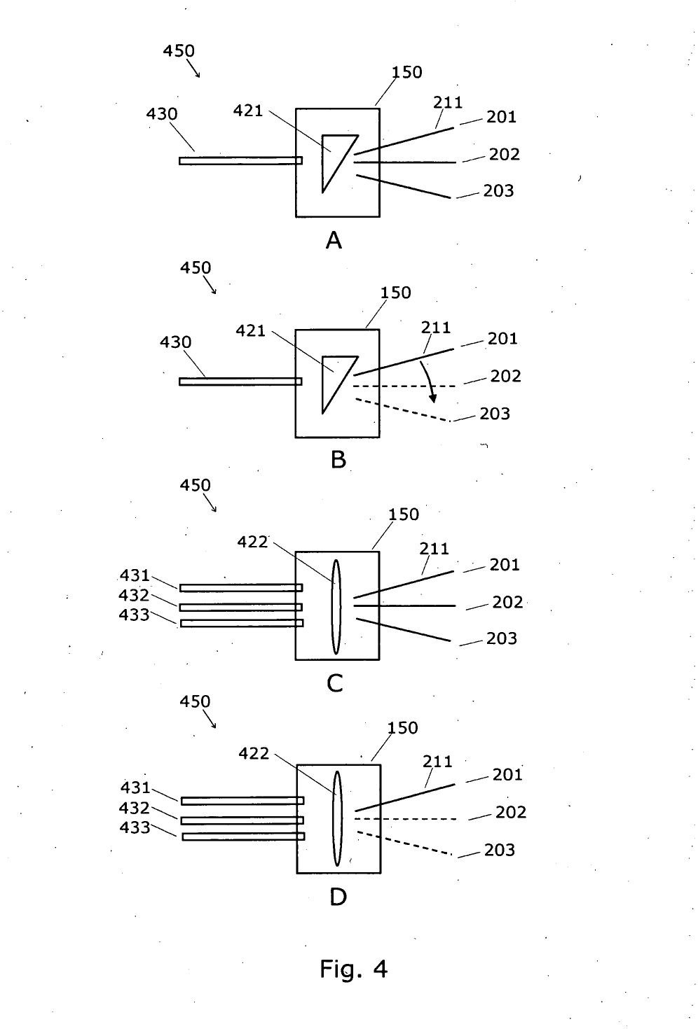

FIG. 4A shows an embodiment of the optical beam generator 450 and the output part 150. The optical beam generator 450 comprises an optical fiber 430 which is capable of transmitting light with a broad spectrum such as white light containing at least first and second different wavelengths w1, w2. The light is transmitted through a prism 421—or other such as a grating—comprised by the output part 150. The prism spreads the white light into different directions 201-203 where the light in each direction has different wavelengths. Accordingly, the output part 150 is configured to output light with the first wavelength w1 in a first direction 201 and light with a second wavelength w2 in a second direction 202. The dispersive element 421 may be arranged in the blade 103 so that beams 211 are outputted directly from the dispersive element, or via other optical elements such as lenses for controlling the divergence of the outputted beams 211.

Since the beams 211 have different wavelengths according to their different directions 201-203, it is possible to determine which of the beams 211 the measured scattered light originates from by use of an optical receiver, such as a spectrometer, which is capable of measuring e.g. light intensity as a function of wavelength. Thereby, the relative wind direction 221 can be determined since it is known what wavelength and thereby beam directions 201-203 the detected pulse lengths or pulse counts are associated with.

FIG. 4B shows an alternative embodiment of the optical beam generator 450 and the output part 150. The optical fiber 430 is capable of transmitting light with a broad spectrum. However, in this embodiment the spectrum of the light transmitted in the fiber 430 varies with time so that light with first and second wavelengths are transmitted at different times, i.e. the first and second wavelengths are present in the spectrum of the transmitted light at different times. The variation in the spectrum of the light transmitted through the fiber may be generated by a tunable laser or a multi-color LED system which are controllable to generate different wavelengths and which are configured to inject light into the fiber 430. Since the light from the fiber is refracted by the dispersing element 421 according to the actual wavelength, beams in different directions 201-203 are generated at different times.

Since the spectrum of the light transmitted in the fiber 430 varies according to a known time dependency, the first and second wavelengths are transmitted at different times and, therefore, it is not required to use a spectrometer since the wavelength of the received light can be determined from the known time dependency of the different wavelengths. Instead a simple intensity sensitive sensor, e.g. a photodiode, can be used for detecting scattered light and the relative wind direction 221 can be determined since it is known from the time dependency of the emitted light what beam directions 201-203 the detected pulse lengths are associated with. Alternatively, if the timing of the spectral variations of the wavelength controllable light source is known—i.e. to which times a light with a given wavelength is generated—the relative wind direction 221 can be determined since it is known what beam direction 201-203 a measured pulse is associated with.

FIG. 4C shows an embodiment of the optical beam generator 450 and the output part 150. The optical beam generator 450 comprises a plurality of optical fibers 431-433 where each of them is capable of transmitting light with a relative narrow spectrum, i.e. light with a single color w1. Accordingly, a first fiber 431 may transmit light with wavelength w1 and a second fiber 432 may transmit light with a different wavelength w2. The light is transmitted through an optical system or optical element 422, e.g. a lens, for spreading the light from first and second fibers 431, 432 into first and second different directions 201, 202. The light from each of the fibers 431-433 may be individually collimated by collimators before being spread into different directions by the optical arrangement 422.

Similarly to the previous embodiments in FIG. 4A-B, the beams 211 have different wavelengths according to their different directions 201-203 and, therefore, it is possible to determine which of the beams 211 the measured scattered light originates from by use of a spectrometer or similar device. Thereby, the relative wind direction 221 can be determined since it is known what wavelength and thereby beam directions 201-203 the detected pulse lengths and/or pulse counts are associated with.

FIG. 4D shows an embodiment with a plurality of optical fibers 431-433 similar to the embodiment in FIG. 4C, but with the difference that light transmission in the first and second optical fibers 431-432 is multiplexed so that output light in the first and second directions 201-202 are generated at different times. Similarly, to the embodiment in FIG. 4B the relative wind direction 221 can be determined by utilizing that the beams 211 have different and distinguishable wavelengths in different beam directions 201-203 or by utilizing that beams 211 are outputted at different times according to their different directions 201-203 so that a spectrometer is not required since the wavelength of the received light can be determined from the known time dependency of the different wavelengths. Thereby, a simple intensity sensitive sensor can be used for detecting scattered light and the relative wind direction 221 can be determined since the timing of the multiplexed beam directions 201-203 is known.

In an alternative embodiment, each of the fibers 431-433 is used for transmitting light with the same narrow or broadband spectrum. In order to be able to determine which of the beams 211 of the same optical color a measured scatter pulse originates from, the light in each of the fibers 431-433 are modulated in light intensity e.g. with different modulation frequencies or different modulations schemes, e.g. different wavelet modulation schemes. Accordingly, the output part 150 is capable of outputting light with a first detectable intensity modulation in first direction and outputting light with a second detectable intensity modulation in a second different direction.

It is possible to determine which of the intensity modulated beams 211 the measured scattered light originates from by use of an optical receiver and a signal analyzer, such as a frequency or FFT analyzer, which is capable of measuring scattered light intensity as a function of e.g. modulation frequency. Thereby, the relative wind direction 221 can be determined since it is known what modulation schemes (e.g. modulation frequencies) and thereby beam directions 201-203 the detected pulse lengths or pulse counts are associated with.

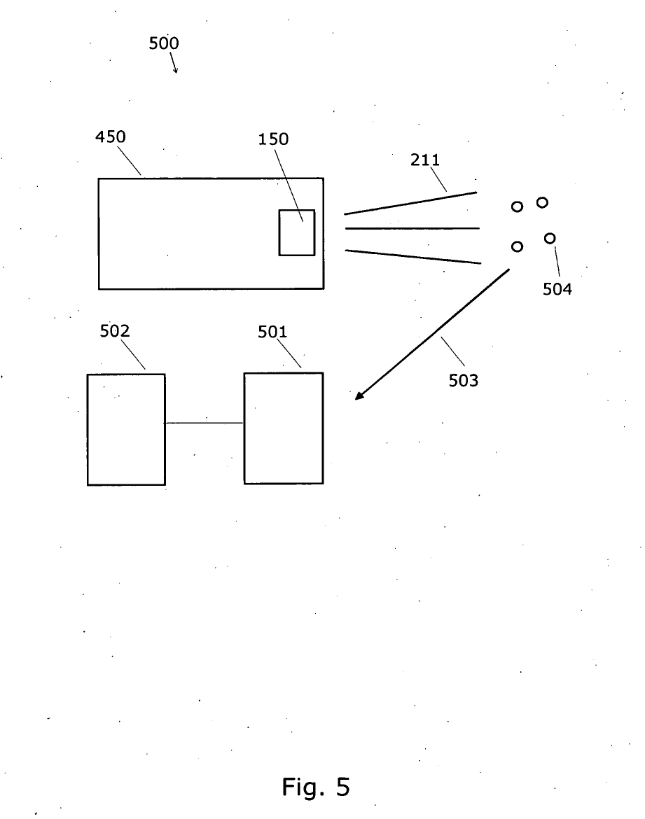

FIG. 5 shows an optical wind detector 500 which comprises an optical beam generator 450. The beam generator 450 comprises the output part 150 for outputting beams 211 in different directions. One or more fibers 430-433 may be used for supplying light to the output part 150, and possibly one or more light sources such as lasers or LED light sources may be used for injecting light into the fibers 430-433. The one or more optical fibers 430-433 or other one or more optical fibers connectable with the fibers 430-433 may extend though the blades and into the hub 104 where the one or more light sources for injecting light into fiber may also be located. Similarly, the same optical fibers 430-433 or other optical fibers may be used for transmitting light received by the optical receiver 501 to optical detectors (photodiode, spectrometer or similar opto-electrical detector) located in the hub 104. Thus, the optical wind detector 500 may be constructed so that it contains no metal or electrical parts since the optical beam generator 450 and the optical receiver 501 only contains optical components and connections between the optical wind detector 500 and the hub 104 may be made using only optical fibers. The optical wind detector 500 further comprises an optical receiver 501 capable of measuring scattered light 503 from air borne particles 504. The optical wind detector 500 may optionally comprise a processor 502 for processing measurements from the optical receiver 501 for determining the relative wind direction 221 and possibly the wind velocity. The processor 502 may be a computer configured to receive analogue or digital values from the optical receiver 501.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

What is claimed is:

1. An optical wind detector for wind turbine generators for determining a relative wind direction relative to a location on a blade of a rotor of the wind turbine generator, the detector comprises
an optical beam generator comprising an output part capable of outputting light in first and second different directions from the location on the blade,
an optical receiver capable of measuring a first optical quantity determined from measured optical scattered light originating from the first direction and a second optical quantity determined from measured optical scattered light originating from the second direction.

2. An optical wind detector according to claim 1, where the first optical quantity is determined as a duration of a pulse and/or a count of pulses of measured optical scattered light originating from the first direction and where the second optical quantity is determined as a duration of a pulse and/or a count of pulses of measured optical scattered light originating from the second direction.

3. An optical wind detector according to claim 1, where the output part comprises an optical dispersion element configured to receive input light with a given spectrum and to output the received light as light with a first wavelength in the first direction and light with a second wavelength in the second direction.

4. An optical wind detector according to claim 3, where the spectrum comprises the first and second wavelengths.

5. An optical wind detector according to claim 4, where the spectrum varies with time so that that the first and second wavelengths are present in the spectrum at different times.

6. An optical wind detector according to claim 1, where the output part comprises first and second optical fibers arranged to output light in the first and second directions.

7. An optical wind detector according to claim 6, where light transmission in the first and second optical fibers is multiplexed so that output light in the first and second directions are generated at different times.

8. An optical wind detector according to claim 1, which further comprises a processor configured to determine the relative wind direction by analysis of the first and second optical quantities.

9. An optical wind detector according to claim 8, where the analysis comprises determining, within a period of time, which of the first and second quantities comprises the longest durations of pulses and/or lowest count of pulses.

10. An optical wind detector according to claim 8, where the analysis comprises interpolating or extrapolating values of the first and second optical quantities for the first and second different directions for determining a direction of the relative wind direction.

11. An optical wind detector according to claim 8, where the processor is further configured to determine wind velocity from the relative wind direction and a rotor speed of the rotor of the wind turbine.

12. An optical wind detector according to claim 8, where the processor is further configured to determine the relative wind direction for different angular positions of the rotor.

13. A wind turbine comprising the optical wind detector according to claim 1.

14. A wind turbine according to claim 13, where the output part is mounted at the location of the blade.

15. A method for determining a relative wind direction relative to a location on a blade of a rotor of a wind turbine generator, the method comprises
outputting light in first and second different directions from the location on the blade by use of an optical beam generator,
determining a first optical quantity from measured optical scattered light originating from the first direction, and
determining a second optical quantity from measured optical scattered light originating from the second direction.
